(19) United States
(12) Patent Application Publication
(10) Pub. No.: US 2006/0237033 A1
(43) Pub. Date: Oct. 26, 2006

(54) CLEANING APPARATUS AND METHOD

(75) Inventors: Hun-Jung Yi, Gyeonggi-do, (KR); Yang-Koo Lee, Gyeonggi-do, (KR); Pil-Kwon Jun, Gyeonggi-do, (KR); Sang-Oh Park, Gyeonggi-do, (KR); Jai-Young Woo, Chuncheongnam-do, (KR)

Correspondence Address: MARGER JOHNSON & MCCOLLOM, P.C., 210 SW MORRISON STREET, SUITE 400, PORTLAND, OR, 97204, US

(73) Assignee: Samsung Electronics Co., Ltd., Gyeonggi-Do (KR)

(21) Appl. No.: 11/380,286

(22) Filed: Apr. 26, 2006

(30) Foreign Application Priority Data
Apr. 26, 2005 (KR) 2005-34666

(51) Int. Cl. B08B 3/00; C23G 1/00

(52) U.S. Cl. 134/2; 134/26; 134/34; 134/95.2

(57) ABSTRACT

In an embodiment, a cleaning apparatus and method can prevent adsorption of nano-size particles by wafers. The apparatus includes a cleaning chamber for filling with a cleaning solution for cleaning an object and a drying chamber disposed over the cleaning chamber for drying the object by supplying drying fluid from an upper part. It also includes a transferring unit for transferring the object by moving it between the cleaning and drying chambers. Further, it includes a moveable exhaust plate disposed between the drying chamber and the cleaning chamber for dividing the two chambers and for exhausting the drying fluid supplied to the drying chamber. The drying fluid flows in a uniform laminar flow in the drying chamber.

### PRIORITY STATEMENTS

This U.S. non-provisional application claims priority under 35 U.S.C. §119 from Korean Patent Application No. 2005-34666, filed on Apr. 26, 2005 in the Korean Intellectual Property Office, the disclosure of which is incorporated herein its entirely by reference.

### BACKGROUND OF THE INVENTION

1. Field of the Invention

The present invention relates to a cleaning apparatus and method, and more particularly, to a cleaning apparatus for preventing a semiconductor wafer from adsorbing nano-size impurities, and a cleaning method using the cleaning apparatus.

2. Description of the Related Art

Generally, fabricating semiconductor devices involves the use of many various materials. Circuit patterns and wires in these devices are formed through multiple process steps. During the process steps, it is often necessary to remove impurities and other contaminants from the surface of a semiconductor wafer that is used to form the device, hereinafter referred to simply as a wafer. Conventionally, cleaning apparatuses are used to remove nano-size particles, organic contaminants, and metal impurities from the surface of the wafer. In particular, a wet-type cleaning apparatus is widely used because it not only removes the contaminants effectively but also performs well in batch processes of many wafers simultaneously.

The wet-type cleaning apparatus performs a chemical cleaning of the wafer using ammonia, hydrofluoric acid, or sulfuric acid, a water cleaning process for cleaning the wafer with deionized water, and a drying process for processing the wafer with isopropyl alcohol (IPA). A wet-type cleaning method widely used is a batch processing method where chemical solutions, deionized water, and isopropyl alcohol are supplied to processing chambers and a drying chamber, which are arranged according to the processing steps, and the wafers are cleaned in the processing chambers and then dried sequentially.

However, when the processing chambers and drying chamber are set tip for the respective processing steps, the overall cleaning apparatus becomes large, and the wafer is more likely to be exposed to air while being transferred to various processing chambers. This increases the chances that nano-size particles will attach to the surface of the wafer. To solve this problem, cleaning apparatuses integrate the processing chambers and drying chamber to perform liquid chemical treatment and drying in the same chamber.

As semiconductor design rules become smaller, it becomes more difficult to satisfy the conditions required for the cleaning process. Particularly, the standards for preventing impurity adsorption become more severe. For example, a threshold defect size under 50 nm may be desired, with the number of these defects totaling less than, say, a few dozen per wafer. To control the adsorption of the impurities of this small size, suppressing the generation of not only the inorganic impurities caused in the conventional wafer or wet-type cleaning apparatus, but also the defects chemically induced in the drying chamber and adsorption onto the wafer is necessary.

However, the above cleaning apparatus has a problem in that the drying chamber is optimized for using deionized water on the wafer during cleaning, which may result in impurities of hundreds to thousands of nanometers being adsorbed onto the entire surface of the wafer or onto parts particularly vulnerable, such as areas that dry relatively slowly. A bare wafer is rinsed and dried and then observed for defects down to a size of 65nm with a measuring instrument. The result is presented in FIG. 1 in which hundreds of impurities are observed in the wafer (B) after the processes, compared to the wafer (A) before the processes.

The minute sizes of impurities may easily lead to defects of the semiconductor device, despite strict fabrication practices. The chances for the generation of defects become higher as the design rule of the semiconductor device becomes smaller. Therefore, an improved cleaning apparatus that can avoid adsorption of nano-size impurities onto the wafer is desired.

### SUMMARY OF THE INVENTION

Embodiments of the present invention provide a cleaning apparatus with a cleaning chamber and a drying chamber integrated together so that a drying fluid flows into the drying chamber in a laminar flow. A method of this cleaning is also provided.

Embodiments of the present invention provide a cleaning apparatus including: a cleaning chamber filled with cleaning solution for cleaning an object; a drying chamber disposed in an upper part of the cleaning chamber and drying the object by supplying drying fluid from an upper part; a transferring means for transferring the object by moving the object between the cleaning chamber and the drying chamber; and an exhaust plate disposed to glide in a lower part of the drying chamber to seal the drying chamber airtight and exhaust the drying fluid supplied to the drying chamber.

In some embodiments of the present invention, the cleaning apparatus includes a plurality of exhaust openings having different opening areas according to disposition in an upper surface of the exhaust plate. The opening areas of the exhaust openings are decreased gradually in a direction from a central part of the wafers to brim. The exhaust openings may include slots.

In another embodiment of the present embodiment, the exhaust plate includes exhaust paths connected to the exhaust openings in the exhaust plate sides. The cleaning apparatus further includes: an exhaust unit which is combined with the exhaust plate and includes an aspirator for forcing the drying fluid to be exhausted and a fluid controlling valve for controlling the quantity of the drying fluid. The exhaust plate is combined with the exhaust unit through a flexible pipe moving flexibly according to gliding operation of the exhaust plate. The flexible pipe is connected to the exhaust paths.

In other embodiments of the present invention, the cleaning apparatus further includes an evaporator for vaporizing the drying fluid and supplying the drying vapor to the drying chamber and including: a nozzle for forming the drying fluid into mist while the drying fluid passes through the nozzle and a heat tank for vaporizing the drying fluid mist by supplying heat to the drying fluid mist. The drying chamber includes a nozzle in the upper part, the nozzle supplying the drying fluid from the evaporator. In the cleaning apparatus of the present embodiment, the height of the drying chamber is 1.5 to 2 times longer than the height of the object.

Another embodiment of the present invention provides a cleaning apparatus including: a cleaning chamber filled with cleaning solution for impregnating and cleaning wafers; a drying chamber which is disposed in the upper part of the cleaning chamber and includes: a nozzle for supplying inert gas and organic solvent for drying the rinsed wafers, and an exhaust plate, which is disposed in the lower part of the drying chamber to make gliding operation and to confront the nozzle, and includes a plurality of exhaust openings for exhausting the inert gas and the organic solvent; a wafer guide for transferring the wafers between the cleaning chamber and the drying chamber by moving up and down and supporting the array of wafers in parallel; an evaporator for supplying the inert gas and the organic solvent to the nozzle of the drying chamber and providing the organic gas in the inert gas in a predetermined concentration; and an exhaust unit combined with the exhaust plate and forcibly exhausting the inert gas and the organic gas out of the drying chamber.

In some embodiments of the present invention, the exhaust openings are disposed in an upper surface of the exhaust plate and have different opening areas according to the disposition on an upper surface of the exhaust plate. The opening areas of the exhaust openings disposed in the central part of the wafers supported by the wafer guide are larger than the opening areas of the exhaust openings disposed in the brim of the wafers. The exhaust plate includes exhaust paths connected to the exhaust openings in sides. The exhaust plate further includes pipes moving flexibly according to gliding operation of the exhaust plate and connecting the exhaust paths to the exhaust unit.

In other embodiments of the present invention, the drying chamber includes a cover in the upper part to open the drying chamber put the wafers into the cleaning apparatus. The height of the drying chamber is 1.5 to 2 times the diameter of the wafers.

In still other embodiments of the present invention, the evaporator includes: a nozzle for forming the organic solvent into mist while the organic solvent passes through the nozzle; and a heat tank for vaporizing the organic solvent mist by supplying heat to the organic solvent mist.

In still other embodiments of the present invention, the exhaust unit includes: a pipe connected to the exhaust plate; a valve for controlling the quantity of the inert gas and the organic solvent flowing through the pipe; and an aspirator for generating an exhaust pressure for exhausting the inert gas and the organic solvent out of the drying chamber.

Some embodiments of the present invention provide a cleaning method, including: a) providing an object to a transferring means in a drying chamber to support the object; b) transferring the object to a cleaning chamber set up in the lower part of the drying chamber by operating the transferring means supporting the object; c) filling the cleaning chamber with cleaning solution and impregnating the object in the cleaning solution to rinse the object; d) transferring the object to the drying chamber by operating the transferring means; e) drying the object while making the drying fluid flow in a laminar flow by gliding an exhaust plate to seal the drying chamber airtight, supplying drying fluid to the drying chamber, and forcing the drying fluid to be exhausted through the exhaust plate; and f) substituting atmosphere of the drying chamber with inert gas.

In some another embodiment of the present invention, the cleaning method further includes: g) substituting the atmosphere of the drying chamber with inert gas before the step a).

In yet another embodiment of the present invention, the cleaning method further includes: h) substituting the atmosphere of the drying chamber with the inert gas and substituting with the drying fluid before the step d).

In still further another embodiment of the present invention, the cleaning method further includes: i) drying the object by supplying the drying fluid into the drying chamber during the step d).

According to the present invention, the cleaning apparatus includes a pipe-type drying fluid supplier formed in the upper part of the drying chamber and a plate-type exhaust unit having exhaust openings in the lower part of the drying chamber. The sizes of the exhaust openings are different whether they are disposed in the central part of the wafers or in the brim. Also, the distance between the drying fluid supplier and the exhaust unit is formed to be approximately 1.5 times the diameter of the wafers. Accordingly, the resistance against the flow of the drying fluid in the central part of the wafers, which is caused by a dense arrangement of the wafers, is offset and the drying fluid flows in a laminar flow.

### BRIEF DESCRIPTION OF THE DRAWINGS

The accompanying drawings, which are included to provide a further understanding of the invention, and are incorporated in and constitute a part of this application, illustrate embodiment(s) of the invention and together with the description serve to explain the principle of the invention. In the drawings:

FIG. 1 is a diagram showing a wafer before and after being cleaned and dried in a semiconductor cleaning apparatus according to a related art;

FIG. 2 is a perspective view describing a semiconductor cleaning apparatus according to an embodiment of the present invention;

FIG. 3 is a perspective view illustrating a wafer guide of the semiconductor cleaning apparatus according to an embodiment of the present invention;

FIG. 4 is a perspective view showing a drying chamber of the semiconductor cleaning apparatus according to an embodiment of the present invention;

FIG. 5 is a perspective view illustrating an evaporator of the semiconductor cleaning apparatus according to an embodiment of the present invention;

FIG. 6 is a plan view describing an exhaust plate of the semiconductor cleaning apparatus according to an embodiment of the present invention;

FIG. 7 is a perspective view showing an exhaust unit of the semiconductor cleaning apparatus according to an embodiment of the present invention;

FIGS. 8 and 9 are cross-sectional views describing the flow of drying fluid of the semiconductor cleaning apparatus with respect to the height of the drying chamber according to an embodiment of the present invention;

FIG. 10 shows wafers before and after being cleaned and dried in the semiconductor cleaning apparatus according to an embodiment of the present invention; and

FIGS. 11 and 12 are perspective views illustrating operation of the semiconductor cleaning apparatus according to an embodiment of the present invention.

### DETAILED DESCRIPTION OF THE INVENTION

Reference will now be made in detail to the preferred embodiments of the present invention, examples of which are illustrated in the accompanying drawings. However, the present invention is not limited to the embodiments illustrated hereinafter, and the embodiments herein are rather introduced to provide easy and complete understanding of the scope and spirit of the present invention.

The advantages of the present invention different from related arts will be made clear through the detailed description and claims with reference to the accompanying drawings. The technological concepts and scope of present invention is particularly claimed in the claims. The accompanying drawings can be best understood with reference to the following detailed description. The same references are given to the same constitutional elements throughout the drawings.

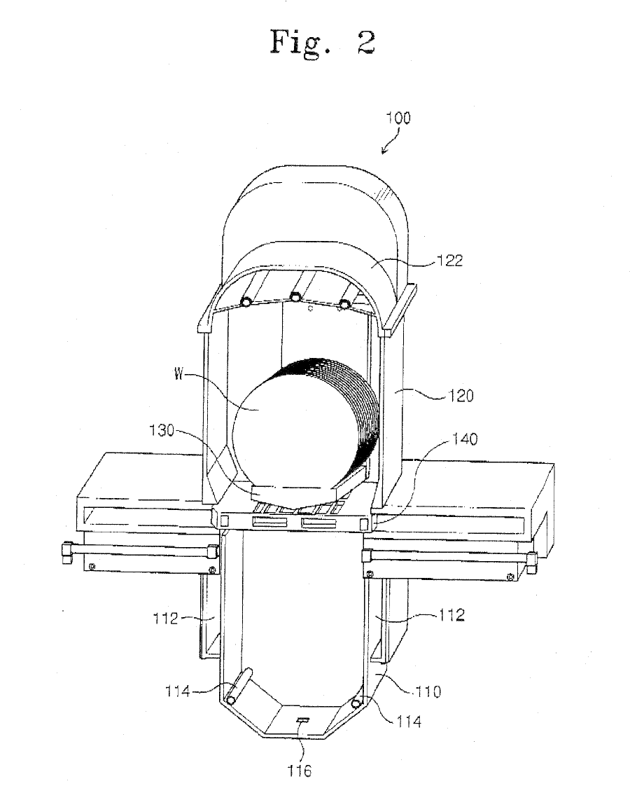

FIG. 2 is a perspective view describing a semiconductor cleaning apparatus according to an embodiment of the present invention.

Referring to FIG. 2, the semiconductor cleaning apparatus includes a cleaning chamber 110 and a drying chamber 120. The cleaning chamber 110 is filled with a chemical solution, such as hydrofluoric acid (HF) or some cleaning mixture, or deionized water as a cleaning solution. A wafer (W) is immersed in the cleaning solution. The drying chamber 120 is disposed over the cleaning chamber 110. The drying chamber 120 is provided to dry the wafer transferred from the cleaning chamber 110.

The cleaning chamber 110 is designed to accommodate a wafer guide 130 and a plurality of wafers (for example, 25 or 50 wafers) supported by the wafer guide 130. The wafer guide 130 supports the wafers so they are arranged on their edges and horizontally stacked in a row, as shown in the embodiment of FIG. 2. The cleaning chamber 110 includes nozzles 114 for supplying the cleaning solution to the wafers on both sides of the bottom of the cleaning chamber 110. The nozzles 114 are formed in a shape that extends in the horizontally arranged direction of the wafers, and a plurality of exhaust openings are formed in the longitudinal direction of the nozzles 114. A drain 116 is formed in the lowermost part of the cleaning chamber 110 to drain the cleaning solution. Also, the cleaning apparatus may further include a collection chamber 112 in the sides of the cleaning chamber 110 for collecting any cleaning solution that overflows the cleaning chamber 110.

The drying chamber 120 also accommodates the wafer guide 130 and a plurality of wafers supported by the wafer guide 130, similar to the cleaning chamber 110. The drying chamber 120 includes a cover 122 in its upper part, which is used to place the wafers into the cleaning apparatus 100. An exhaust plate 140, which will be described later, is between the drying chamber 120 and the cleaning chamber 110. The exhaust plate 140 allows cleaning by a moving operation, wherein the exhaust plate 140 divides the drying chamber 120 from the cleaning chamber 110.

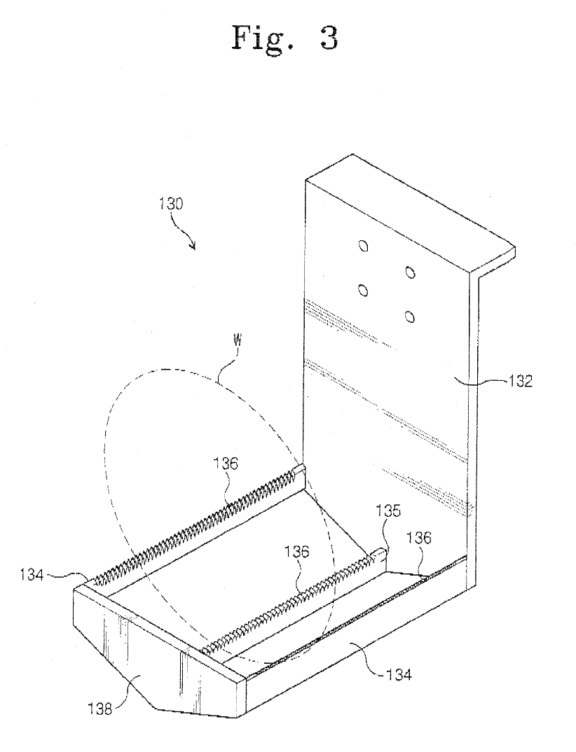

FIG. 3 is a perspective view illustrating a wafer guide of the semiconductor cleaning apparatus according to the present embodiment of the invention.

Referring to FIG. 3, the wafer guide 130 includes a wafer supporter 134 for supporting a plurality of wafers (for example, 25 or 50 wafers) arranged standing up in parallel in the lower part of the wafer supporting unit 132. Two wafer supporters 134 are provided to right and left sides of the lower part of the wafer supporting unit 132. One end of the wafer supporter 134 is fixed onto the lower part of the wafer supporting unit 132, and the other end is connected with a fixing unit 138. The wafer supporters 134 include a plurality of wafer supporting grooves 136, e.g., 25 or 50 wafer supporting grooves, with a predetermined space from each other in the longitudinal direction of the wafer supporters 134. Although the present embodiment presents two wafer supporters 134 in the right and left sides, more wafer supporters 135 can be formed between the two wafer supporters 134. The wafer guide 130 performs ascending and descending operations within the semiconductor cleaning apparatus 100 to transfer wafers between the cleaning chamber 110 and the drying chamber 120.

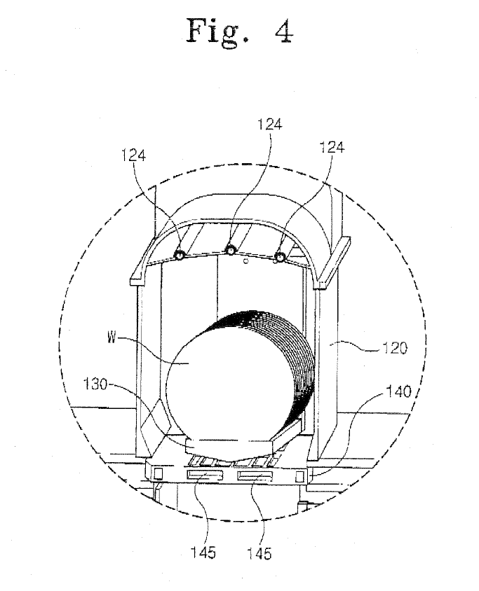

FIG. 4 is a perspective view showing the drying chamber of the semiconductor cleaning apparatus according to an embodiment of the present invention.

Referring to FIG. 4, the drying chamber 120 dries the wafers transferred after they are rinsed in the cleaning chamber 110, as described above. The drying chamber 120 includes a plurality of nozzles 124 for supplying nitrogen gas or a gas mixture of nitrogen and isopropyl alcohol downward onto the wafers supported by the wafer guide 130. Through the nozzles 124, drying fluid, such as nitrogen, isopropyl alcohol, or a mixture, flows into the drying chamber 120. Preferably, the concentration of isopropyl alcohol in a mixed fluid of nitrogen and isopropyl alcohol should be sufficiently high to perform drying without generating nano-size particles and adsorption onto the wafers.

However, when the concentration of isopropyl alcohol is raised, an undesirable chemical reaction may occur with the wafers or a particular material on the wafers. Thus, it is desirable to set up the concentration of isopropyl alcohol differently according to each process. For this, isopropyl alcohol is supplied by an evaporator that can control the concentration of the isopropyl alcohol by, say, ±5%. The evaporator 200 (FIG. 2), as an example only, may control the concentration of the isopropyl alcohol within a range of 5 to 25% and may maintain the concentration variance under ±5%.

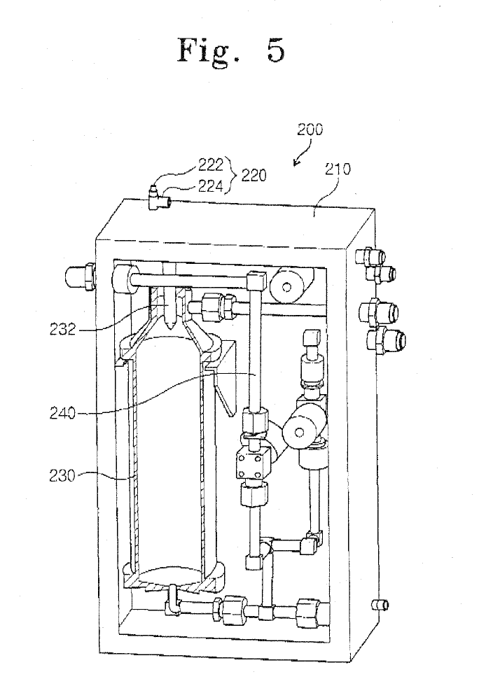

FIG. 5 is a perspective view illustrating the evaporator of the semiconductor cleaning apparatus according to an embodiment of the present invention.

Referring to FIG. 5, the evaporator 200 includes a heat tank 230 within a rectangular body 210. The heat tank 230 vaporizes the drying fluid from a liquid to a gas. The heat tank 230 includes a nozzle 232 for supplying the drying solution to the inside of the heat tank 230 in the form of a mist. The body 210 includes a supplying pipe 220 for supplying the drying solution to the inside of the heat tank 230. The drying solution is sprayed in the form of a mist into the inside of the heat tank 230 through the nozzle 232 and heated to be vaporized. The supplying pipe 220 is formed to supply the drying solution to the inside of the heat tank 230 individually according to the desired kind of the drying solution. For example, it can be formed of a pipe 222 for supplying nitrogen gas and a pipe 224 for supplying liquid isopropyl alcohol. The heat tank 230 further includes an exhaust pipe 240 for exhaust nitrogen, isopropyl alcohol or a mixture of nitrogen and isopropyl alcohol. The exhaust pipe 240 is connected to the nozzle 124 of the drying chamber 120 to transfer the drying solution to the drying chamber 120.

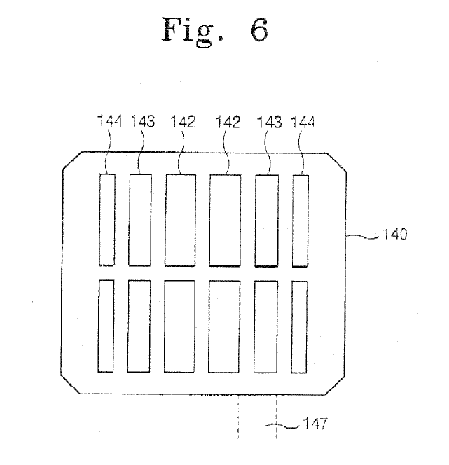

FIG. 6 is a plan view describing an exhaust plate of the semiconductor cleaning apparatus according to the embodiment of the present invention.

Referring to FIGS. 4 and 6, the exhaust plate 140 is provided between the drying chamber 120 and the cleaning chamber 110. The exhaust plate 140 can perform gliding operations to spatially connect or disconnect the cleaning chamber 110 and the drying chamber 120. The exhaust plate 140 includes a plurality of exhaust openings 142, 143, and 144 to exhaust the drying solution within the drying chamber 120. The exhaust openings 142, 143, and 144 are arranged so that the opening areas become smaller gradually, from the center to the edge of the wafers held in the wafer supporter 134. That is to say, the exhaust opening 142 provided corresponding to the center of the wafers is wider than that of the exhaust opening 144 corresponding to the edge of the wafers. The exhaust opening 143 is narrower than that of the exhaust openings 142 but is wider than that of the exhaust opening 144. Because the exhaust opening 142 is wider than that of the exhaust opening 144, the resistance against the flow of the drying solution at the center of the wafers, which is normally higher than at the wafers' edge due to the dense array of the wafers standing up in parallel, is reduced. The exhaust plate 140 has exhaust paths 145 (FIG. 4) in the sides, and the exhaust paths 145 are connected to an exhaust pipe 147. Preferably, the exhaust pipe 147 is formed of a material that can move flexibly when the exhaust plate 140 makes its moving operation.

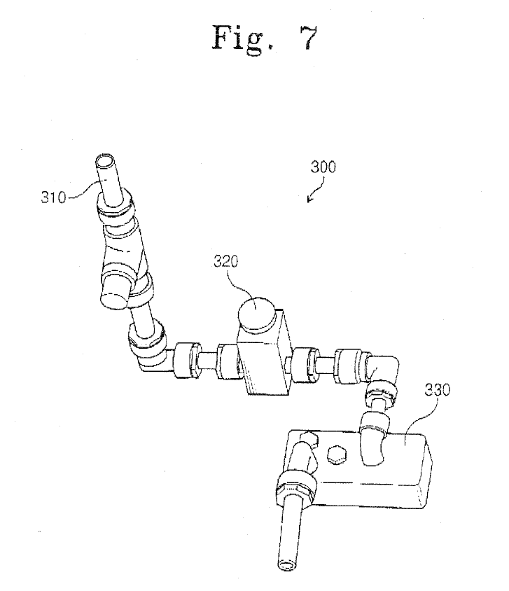

FIG. 7 is a perspective view showing the exhaust unit 300 of the semiconductor cleaning apparatus according to the embodiment of the present invention.

Referring to FIG. 7, the exhaust unit 300 forces the drying solution to be exhausted to maintain the pressure of the drying chamber 120 at a predetermined value. The exhaust unit 300 includes a pipe 310 linked with the flexible exhaust pipe 147 (FIG. 6) connected to the exhaust paths, a fluid controlling valve 320, and an aspirator 330. The exhaust pressure is generated by an aspirator 330 using negative pressure induced when a gas flows at a high speed. The fluid controlling valve 320 is set up between the drying chamber 120 and the aspirator 330 to control the quantity of the exhausted drying solution and to control the pressure of the drying chamber 120. With the above structure, the drying solution in the drying chamber 120 passes through the supported wafers and is forced to be exhausted outside through the exhaust openings 142, 143 and 144.

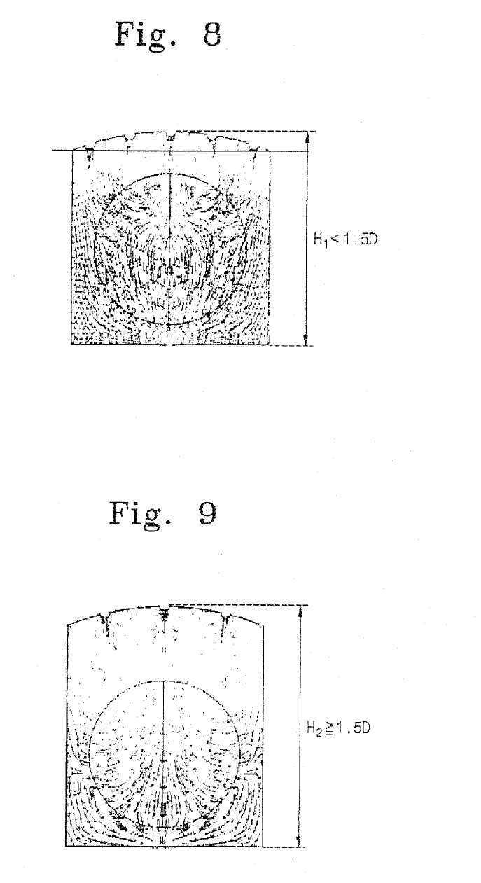

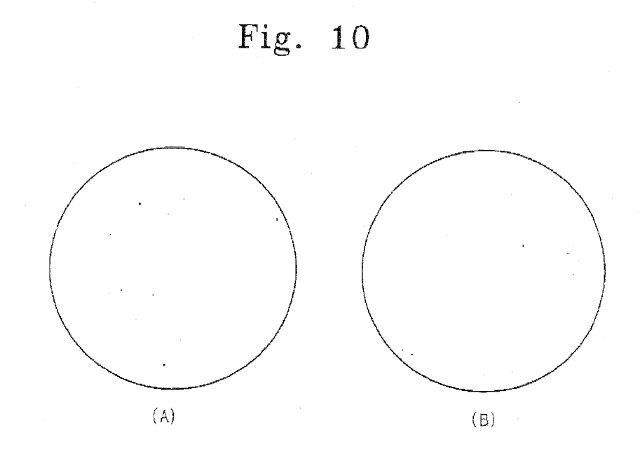

FIGS. 8 and 9 are cross-sectional views describing the flow of drying fluid of the semiconductor cleaning apparatus with respect to the height of the drying chamber according to the embodiment of the present invention.

Referring to FIG. 8, when the height H1 of the drying chamber 120 is smaller than 1.5-times of the wafer diameter D, fluid dynamical whirl flows form in the drying chamber 120, particularly in the upper right and left parts of the wafers. The whirl flows may raise the chances of nano-size particles adsorbed onto the wafers.

Referring to FIG. 9, when the height H2 of the drying chamber 120 is longer than 1.5 to 2 times of the wafer diameter, sufficient space can be secured in the upper part of the drying chamber 120. This sufficient space allows the flow of the drying solution to be more uniform as compared with the case in FIG. 8. The drying solution flows substantially straight downward in the drying chamber 120. The exhaust plate 140 reduces the resistance of flow along the wafer center. Therefore, it is possible to make the drying solution flow laminarly all over the surfaces of the wafers. The uniform laminar flow prevents adsorption of impurities to the surfaces of the wafers.

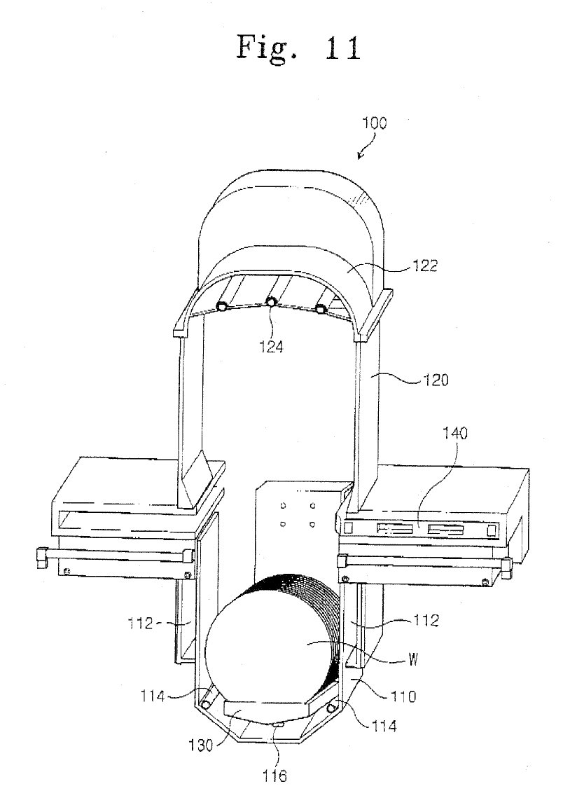

FIG. 10 shows wafers before and after being cleaned and dried in the semiconductor cleaning apparatus according to the embodiment of the present invention.

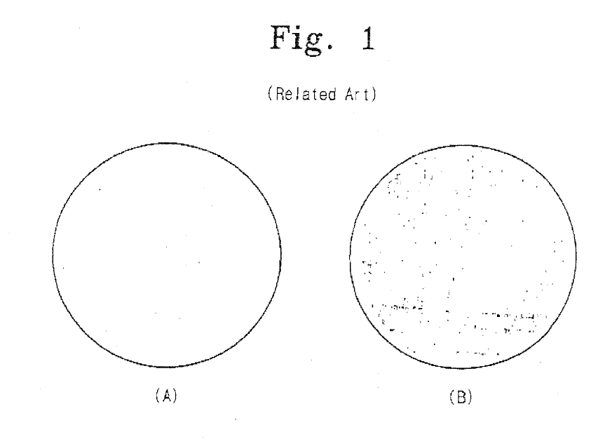

FIG. 10 shows a wafer A before the processes and a wafer B after the processes. There are little defects or impurities on the surface of the wafer B compared to the wafer B of FIG. 1.

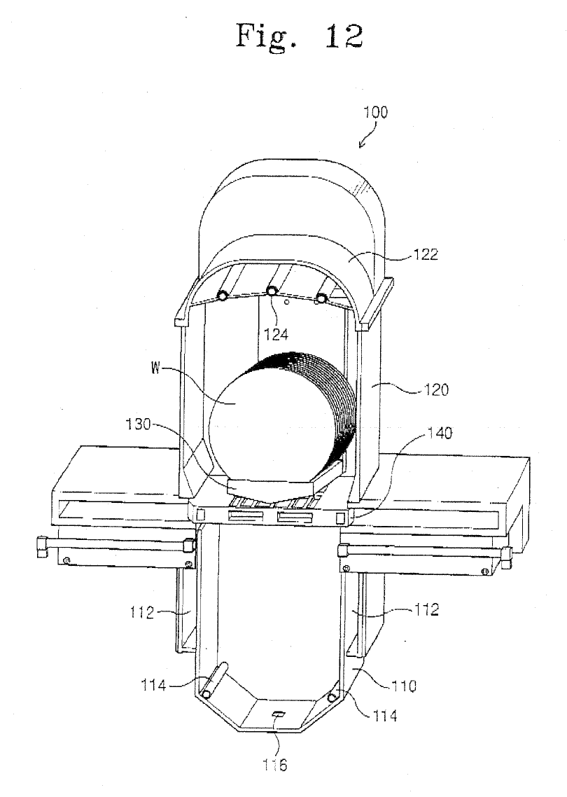

Hereinafter, a cleaning method using the semiconductor cleaning apparatus will be described with reference to FIGS. 11 and 12.

Referring to FIG. 11, the cover 122 in the upper part of the drying chamber 120 is open and the wafers are transferred from the outside to the drying chamber. Then the wafers are loaded on the wafer guide 130 for cleaning. Nitrogen gas may be supplied through the nozzles 124 to the drying chamber 120 or to both the chambers 110 and 120 prior to loading wafers. Subsequently, a cleaning solution, e.g., hydrofluoric acid or a mixture thereof, is supplied into the cleaning chamber 110 through the nozzles 114. Then the wafer guide 130 is lowered into the cleaning chamber 110 filled with the cleaning solution until the wafers are immersed in the cleaning solution. The cleaning chamber 110 may be filled with the cleaning solution in advance before the wafers are set into the cleaning chamber 110.

The cleaning process can be performed by conventional methods. For example, as for the cleaning solution, hydrofluoric acid or mixture of hydrofluoric acid and deionized water (H2O) is used. The hydrofluoric acid dispensed through the nozzles 114 forms a current toward the wafers in the cleaning chamber 110. This current promotes the wafer cleaning. Subsequently, the hydrofluoric acid is exhausted out through the drain 116 and deionized water (DIW) is supplied through the nozzles 114 to perform wafer rinsing. The deionized water can promote the rinsing by forming a current toward the wafers in the cleaning chamber 110. Without draining the hydrofluoric acid, the deionized water can be supplied into the cleaning chamber 110 filled with hydrofluoric acid so that the hydrofluoric acid solution becomes gradually less concentrated.

While the cleaning process is performed, the drying chamber 120 is filled with isopropyl alcohol. Differently, nitrogen gas may be supplied and then isopropyl gas, which may include nitrogen gas, is supplied into the drying chamber 120. Then the wafers are transferred to the drying chamber 120 by raising the wafer guide 130.

Referring to FIG. 12, the exhaust plate 140 is moved, or shifted, into place to seal the drying chamber 120 airtight and then isopropyl alcohol or a mixture of isopropyl alcohol and nitrogen gas is supplied to the wafers through the nozzles 124 of the drying chamber 120. Accordingly, isopropyl alcohol is condensed on the surfaces of the wafers to reduce the surface tension of the cleaning solution or deionized water on the surfaces of the wafers so that the cleaning solution or deionized water is easily removed from the surfaces of the wafers by merely dropping off by gravity. This way, the wafers are dried. Subsequently, nitrogen gas is supplied through the nozzles 124 to purge the isopropyl alcohol out of the drying chamber 120.

During the drying process, the drying solution, which is nitrogen or a mixture gas of isopropyl alcohol and nitrogen, is provided to the drying chamber 120 from the upper part and forced to be exhausted through the exhaust plates 140 under the drying chamber 120. As mentioned earlier, the opening areas of the exhaust openings 142 to 144 become smaller from the center, corresponding to the center of the wafers, to the edge, corresponding to the edge of the wafers. The flow resistance along the center of the wafer may be reduced. Therefore, the drying solution has a laminar flow all over the drying chamber 120 so that drying is improved.

The above described cleaning and drying processes are no more than examples of the present invention and it would be apparent to those skilled in the art that there can be other examples. To take an example, when the cleaning is completed, the drying chamber 120 can be filled with nitrogen gas by supplying nitrogen gas to the drying chamber 120 through the nozzles 124 and then supplying isopropyl alcohol in the form of mist together with the nitrogen gas through the nozzles 124 to thereby form an isopropyl alcohol layer in the cleaning solution. Subsequently, the deionized water or cleaning solution is removed from the surfaces of the wafers based on the Marangoni effect by raising the wafer guide 130 to make the wafers pass through the isopropyl alcohol layer formed in the cleaning solution.

When the wafers ascend completely, the exhaust plate 140 is shifted into place to seal the drying chamber 120 airtight and the wafers are dried by supplying the mixture gas of nitrogen and isopropyl alcohol through the nozzles 124 and, simultaneously, forcing the mixture gas of the drying chamber 120 through the exhaust plate 140 to make the mixture gas flow in the uniform laminar flow. Then, isopropyl alcohol remaining on the surfaces of the wafers is removed by supplying nitrogen gas through the nozzles 124. Nitrogen gas may be heated. The concentration of isopropyl alcohol used in the drying process can be the same as or different from the isopropyl alcohol concentration used in the previous drying process, if necessary or process conditions require. For example, the isopropyl alcohol can be supplied in a low concentration in the previous drying process and it can be provided in a high concentration in the later drying process.

Although hydrofluoric acid or a mixture of hydrofluoric acid and deionized water is used as the cleaning solution in the above-described embodiment, other solutions, e.g., a mixture solution of ammonia/hydrogen peroxide/deionized water (NH₄/H₂O₂/H₂O), a mixture solution of hydrochloric acid/hydrogen peroxide/deionized water (HCL/H₂O₂/H₂O), or a mixture thereof can be used as the cleaning solution. Also, although the present embodiment uses nitrogen gas, it is possible to use period table, group 0 gases such as Ar and He instead of nitrogen gas. Also, the present embodiment uses isopropyl alcohol as a water-soluble organic solvent to reduce the surface tension of deionized water or processing solution on the wafers. However, it is possible to use primary alcohol such as methanol, ketone such as acetone, ether such as ethylether, or polyvalent alcohol such as ethyleneglycol. The objects of the cleaning and drying processes are not limited to semiconductor wafers but they can be plasma displays or liquid crystal display substrates, or photomask substrates, for example.

As described above, the present invention makes the drying solution flow in a laminar fashion over the surfaces of the wafers standing up in the drying chamber to prevent the wafers from adsorbing minute impurities. Accordingly, the present invention can bring about an effect of increased throughput or increased semiconductor device production efficiency. In addition, it can supply a concentration of isopropyl alcohol vaporized in ambient nitrogen in a wide concentration range.

The above description only exemplifies the present invention and presents preferred embodiments of the present invention, and the present invention can be applied to diverse environments after modification. It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A cleaning apparatus, comprising:
a cleaning chamber configured to fill with a cleaning solution for cleaning an object;
a drying chamber provided over the cleaning chamber for drying the object by supplying drying fluid;
a transferring means for transferring the object between the cleaning chamber and the drying chamber; and
an exhaust plate moveable to divide the drying chamber and the cleaning chamber, the exhaust plate configured to exhaust the drying fluid.

2. The apparatus of claim 1, wherein the exhaust plate includes a plurality of exhaust openings having different areas according to their disposition on an upper surface of the exhaust plate.

3. The apparatus of claim 2, wherein the areas of the exhaust openings decrease gradually in a direction from a center part to an edge part of the upper surface of the exhaust plate.

4. The apparatus of claim 2, wherein the exhaust openings include slot shapes.

5. The apparatus of claim 2, wherein the exhaust plate includes exhaust paths connected to the exhaust openings.

6. The apparatus of claim 5, further comprising:
an exhaust unit which is combined with the exhaust plate, wherein the exhaust unit includes an aspirator for forcing the drying fluid to be exhausted and a fluid control valve for controlling the quantity of the drying fluid.

7. The apparatus of claim 6, wherein the exhaust plate is combined with the exhaust unit through a flexible pipe moving flexibly according to a moving operation of the exhaust plate.

8. The apparatus of claim 7, wherein the flexible pipe is connected to the exhaust paths.

9. The apparatus of claim 1, further comprising:
an evaporator for vaporizing and supplying the drying fluid to the drying chamber, wherein the evaporator includes a first nozzle for forming the drying fluid into a mist and a heat tank for vaporizing the drying fluid.

10. The apparatus of claim 9, wherein the drying chamber includes a second nozzle in an upper part, the second nozzle supplying the drying fluid from the evaporator.

11. The apparatus of claim 1, wherein an interior height of the drying chamber is 1.5 to 2 times greater than that of the object.

12. A cleaning apparatus for cleaning wafers, comprising:
a cleaning chamber for filling with a cleaning solution;
a drying chamber disposed over the cleaning chamber, the drying chamber including a nozzle disposed in an upper part thereof for supplying gas and organic solvent and a moveable exhaust plate disposed in the lower part thereof, wherein the moveable exhaust plate includes a plurality of exhaust openings for exhausting the gas and the organic solvent;
a wafer guide for transferring the wafers between the cleaning chamber and the drying chamber by moving up and down and supporting the wafers arranged standing in parallel;
an evaporator for supplying the gas and the organic solvent to the nozzle of the drying chamber and providing a predetermined concentration of evaporated organic solvent in the gas; and
an exhaust unit combined with the moveable exhaust plate to forcibly exhaust the gas and the evaporated organic solvent out of the drying chamber.

13. The apparatus of claim 12, wherein the exhaust openings are disposed in an upper surface of the moveable exhaust plate and have different opening areas according to their position on the upper surface of the moveable exhaust plate.

14. The apparatus of claim 12, wherein the areas of the exhaust openings corresponding to the central part of the wafers supported by the wafer guide are larger than the areas of the exhaust openings corresponding to the edge of the wafers.

15. The apparatus of claim 12, wherein the moveable exhaust plate includes exhaust paths connected to the exhaust openings in sides of the moveable exhaust plate.

16. The apparatus of claim 15, wherein the moveable exhaust plate further includes flexible pipes to move flexibly according to a movement of the moveable exhaust plate, the flexible pipes connecting the exhaust paths to the exhaust unit.

17. The apparatus of claim 12, wherein the drying chamber includes a cover in its upper part to open the drying chamber and place the wafers into the cleaning apparatus.

18. The apparatus of claim 12, wherein the evaporator includes:
a second nozzle for forming the organic solvent into a mist while the organic solvent passes through the second nozzle; and
a heat tank for vaporizing the organic solvent mist by supplying heat to the organic solvent mist.

19. The apparatus of claim 12, wherein the exhaust unit includes:
a pipe connected to the moveable exhaust plate;
a valve for controlling the quantity of the gas and the organic solvent flowing through the pipe; and
an aspirator for generating an exhaust pressure for exhausting the inert gas and the organic solvent out of the drying chamber.

20. The apparatus of claim 12, wherein an interior height of the drying chamber is 1.5 to 2 times the diameter of the wafers.

21. A method to clean an object, comprising:
a) providing the object to a transferring means in a drying chamber;
b) transferring the object to a cleaning chamber provided under the drying chamber by operating the transferring means;
c) filling the cleaning chamber with a cleaning solution and immersing the object in the cleaning solution to rinse the object;
d) transferring the object to the drying chamber by operating the transferring means;
e) drying the object while causing the drying fluid to flow laminarly by moving an exhaust plate to close the drying chamber, supplying drying fluid to the drying chamber, and forcing the drying fluid to be exhausted through the exhaust plate; and
f) supplying the drying chamber with inert gas.

22. The method of claim 21, further comprising, before the step a):
supplying the drying chamber with inert gas.

23. The method of claim 21, further comprising, before the step d):
supplying the drying chamber with the drying fluid after supplying the drying chamber with the inert gas.

24. The method of claim 21, further comprising, simultaneously with the step d):
drying the object by supplying the drying fluid into the drying chamber.
